(19) United States
(12) Patent Application Publication
(10) Pub. No.: US 2002/0026352 A1
(43) Pub. Date: Feb. 28, 2002

(54) Method and apparatus for adjusting a condition for using a collective site

(76) Inventor: Kenji Murata, Tokyo (JP)

Correspondence Address: Thomas R. Morrison, Esq., MORRISON LAW FIRM, 145 North Fifth Avenue, Mount Vernon, NY, 10550, US

(21) Appl. No.: 09/733,322

(22) Filed: Dec. 8, 2000

(30) Foreign Application Priority Data
Aug. 30, 2000 (JP) 2000-261300

(51) Int. Cl. G06F 17/60

(52) U.S. Cl. 705/14; 705/26

(57) ABSTRACT

A method and apparatus for adjusting a condition of using a collective site for a plurality of registrants who have been registered in advance, wherein at least one of advertisements and transactions is carried out regarding the registrants, is presented. A contributory degree of advertisements carried by each registrant is evaluated. If each registrant has their own advertising resources, such as a website or a mailing list, each registrant bestows slight cost and small effort to advertise the collective site. For example, they can use a part of spaces or times for their own advertisements to advertise the collective site. After evaluating the contributory degree, a condition of using for each registrant is adjusted in accordance with the contributory degree. The higher the contributory degree of advertisements carried by each registrant, the more the number of the audiences of the collective site will increase. The effect of the advertisements influences on the condition of using for each registrant as the contributory degree. For example, if the effect of the advertisements and the contributory degree are both high, the condition of using for the registrant is profitably adjusted.

### BACKGROUND OF THE INVENTION

1. Field of the Invention

The present invention relates to a method and apparatus for adjusting a condition of using a collective site for a plurality of registrants who have been registered in advance, wherein at least one of advertisements and transactions is carried out regarding the registrants.

2. Description of the Prior Art

Recently, websites have become essential means for entrepreneurs in advertising and trading their goods and services. There are many such websites, having various kinds of operation modes. One of the operation modes of a website is a collective site. The collective site posts advertisements and provides surroundings for transactions regarding a plurality of registrants who have been registered in advance. Examples of the collective site include a shopping mall site, a link listed site and the like.

The shopping mall site is a website formed by a plurality of stores each opened by their own owner, similar to a real mall. In the shopping mall site, territories are assigned to each store in order to carry out advertisements and transactions for their goods and services on webpages provided in the shopping mall site. The territory may be a part of a single webpage as well as one or more webpages. Further, unlike a real mall, the goods and services are displayed by a kind of goods and services as well as for each store. Certainly, in a case where the goods and services are displayed by the kind of goods and services, names of the stores are positioned corresponding to the goods or services. This is also a kind of territory assigned to each store. There is a possibility that some stores within the shopping mall site may sell the same goods at different prices. The more stores that are opened, the more goods and services are handled, resulting in a collective site that provides more options available to audiences than that of a shopping site which provides the goods and services of a single entrepreneur.

The link-listed site is a website which mainly provides webpage, gathering banner advertisements and links, which advertise at least one of goods, services and registrants own website. Usually, each link-listed site has one or more themes such as “Information Site for Women”. In accordance with these themes, links regarding the websites themselves, goods and services are gathered. If the audiences have themes along which they want to know information, the audiences can get information to a certain extent by visiting the link-listed site, even if they do not know the other websites regarding the themes. If the audiences are satisfied with the information obtained from the link-listed site, the frequency of the audiences' visit to the other websites, which are not linked with the link-listed site, will reduce. Therefore, the registrants can make at least one of goods, service, and their websites known if only they linked their websites with the link-listed site. This is enough advertisement for the registrants.

These types of collective sites are useful for the audiences because a lot of information, which they want to know, is gathered on the site. The collective site has a possibility to hold a large audience. If the collective site is synthesized by opening stores and linking with websites over various genres, the audiences can obtain various information by only memorizing the URL of the collective site. Then, a repeat rate of the audiences will become higher automatically.

For the above reasons, there are some people who register with collective sites, like those described above, even if they have their own advertising resources such as a website. However, the collective site does not always function efficiently. If the size of the audience of the collective site is small, the number of registrants will also become small corresponding to the size of the audiences. If the number of the registrants is small, the size of the audiences will not increase. There is a possibility of such a vicious circle.

Furthermore, even though it is efficient for the registrants to use the collective site, costs, such as a registration fee and efforts for maintenance, still mount up in a case where the registrants have their own advertising resources such as their own website. Therefore, there is a possibility that an incentive for the registrants to use the collective site will decrease.

### SUMMARY OF THE INVENTION

It is an object of the present invention to provide a method and apparatus for adjusting a condition of using a collective site which overcomes the forgoing problems.

One embodiment of the present invention is a method of adjusting a condition of using a collective site for a plurality of registrants who have been registered in advance, wherein at least one of advertisements and transactions is carried out regarding the registrants. This embodiment of the present invention comprises the steps of evaluating a contributory degree of advertisements for the collective site, which are carried out by each registrant, and adjusting the condition of using for each registrant in accordance with the contributory degree.

According to this feature of the present invention, the contributory degree of advertisements carried out by each registrant is evaluated. The condition of using collective site is adjusted in accordance with the contributory degree.

If each registrant has their own advertising resources, such as their own website or a mailing list, each registrant bestows slight cost and small effort in order to advertise the collective site. For example, they can use a part of spaces and times for their own advertisements in order to advertise the collective site.

The higher the contributory degree of advertisements carried out by each registrant, the larger the size of the audience of the collective site. The effect of the advertisements is to influence the condition of using the collective site as the contributory degree. For example, if the effect of the advertisements and the contributory degree as well are high, the condition of using for each registrant is profitably adjusted. Therefore, the incentive for each registrant to use the collective site is also be enhanced.

However, if the size of the audience of the collective site increases due to advertisements carried out by some of the registrants, there appears a possibility that profits given to the other registrants who use the collective site will also increase. If the conditions of using for the other registrants, who do not advertise the collective site, or whose advertisements for the collective site do not make enough effect, are maintained, the condition of using for the other registrants will be relaxed relatively, even though they either do not advertise the collective site or the effects of their advertisements are not enough. In such circumstance, there is a possibility that some of the registrants who carried out enough advertisements will lose their incentive to advertise the collective site continuously.

For this reason, in the method of adjusting a condition of using a collective site, it is preferable that, before the condition of using is adjusted, the profit degree given to each registrant by using the collective site is evaluated. Then, the condition of using is adjusted in accordance with the profit degree as well as the contributory degree.

The profit degree also influences on the condition of using for each registrant. For example, when the profit degree given to each registrant by using the collective site increases, the condition of using is unprofitably adjusted for each registrant.

In this way, the above circumstance are avoided. Needless to say, even if the condition of using is unprofitably adjusted for the registrants, the registrants whose conditions are adjusted unprofitably never lose their incentive to use the collective site because they obtain appropriate profits. In the method of adjusting a condition of using a collective site, examples of the condition of using to be adjusted are a fee for using the collective site for each registrant and a degree of priority in assigning webpages provided in the collective site to each registrant.

If the fee for using the collective site is reduced, the burdens on each registrant are lightened and the incentive for each registrant to use the collective site is enhanced. Further, the degree of priority in assigning webpages provided in the collective site to each registrant becomes higher, for example, when advertisements of the regisrants for their goods and services are positioned on a part of the webpage to which audiences often pay attention. In such a case, the incentive for the registrants to use the collective site is enhanced, even if the fee for using the collective site is maintained or should not have been paid.

Still further, a representative example of the collective site adjusting a condition of using is a shopping mall site which assigns territories to each registrant to carry out advertisements and transactions for their goods and services on the webpages which are provided in the collective site.

A further embodiment of the present invention is an appropriate apparatus for practicing the method of adjusting a condition of using a collective site. An apparatus for adjusting a condition of using a collective site for a plurality of registrants who have been registered in advance, wherein at least one of advertisements and transactions is carried out regarding the registrants, includes a contributory degree evaluating means, a profit degree evaluating means and a condition adjusting means. The contributory degree evaluating means evaluates the contributory degree of advertisements for the collective site which are carried out by each registrant. The profit degree evaluating means evaluates the profit degree which is given to each registrant by using the collective site. The condition adjusting means adjusts the condition of using for each registrant in accordance with the contributory degree and the profit degree.

In the apparatus for adjusting a condition of using a collective site, the contributory degree of advertisements for the collective site carried out by each registrant is evaluated by the contributory degree evaluating means. The profit degree given to each registrant by using the collective site is also evaluated by the profit degree evaluating means. Further, the condition of using the collective site is adjusted in accordance with the contributory degree and the profit degree.

In this way, while the number of the audiences of the collective site increases, the incentive for the registrants to use the collective site is enhanced. This enhancement occurs without losing the registrant's incentive to advertise the collective site.

The above, and other objects, features, and advantages of the present invention will become apparent from the following description read in conjunction with the accompanying drawings, in which like reference numerals designate the same elements.

### BRIEF DESCRIPTION OF THE DRAWINGS

FIG. 1 is a schematic drawing of an apparatus for adjusting a condition of using a collective site according to one embodiment of the present invention.

FIG. 2 is a figure explaining a construction of the collective site and the delivery of information using the collective site.

FIG. 3 is a figure illustrating an example of a construction of an advertising result database.

FIG. 4 is a figure illustrating an example of a construction of a contributory degree evaluating database.

FIG. 5 is a figure illustrating an example of a construction of a using result database.

FIG. 6 is a figure illustrating an example of a construction of a profit degree evaluating database.

FIG. 7 is a figure illustrating an example of a construction of a condition adjusting database.

FIG. 8 is a figure explaining a method of constructing the advertising result database and the using result database.

### DETAILED DESCRIPTION OF THE INVENTION

In the following detailed description numerous specific details are set forth in order to provide a thorough understanding of the present invention. However, it will be understood by those skilled in the art that the present invention may be practiced without these specific details. In other instances, well known methods, procedures, components, and circuits have not been described in detail so as not to obscure the present invention.

A preferred embodiment of the present invention is embodied as an apparatus for adjusting a condition of using a shopping mall site for a plurality of registrants who have been registered in advance. Advertisements and transactions for at least one of goods and services are carried out regarding the registrants of the shopping mall site.

In the shopping mall site, virtual stores are opened by each registrant. That is to say, webpages, in which the advertisements and transactions for at least one of goods and services are carried out, are classified into some genres, for example, home appliances, books, and so on. As the audiences trace links corresponding to a genre, a list of stores (list of linked webpages), which belong to the selected genre, is displayed on a web browser of the audiences.

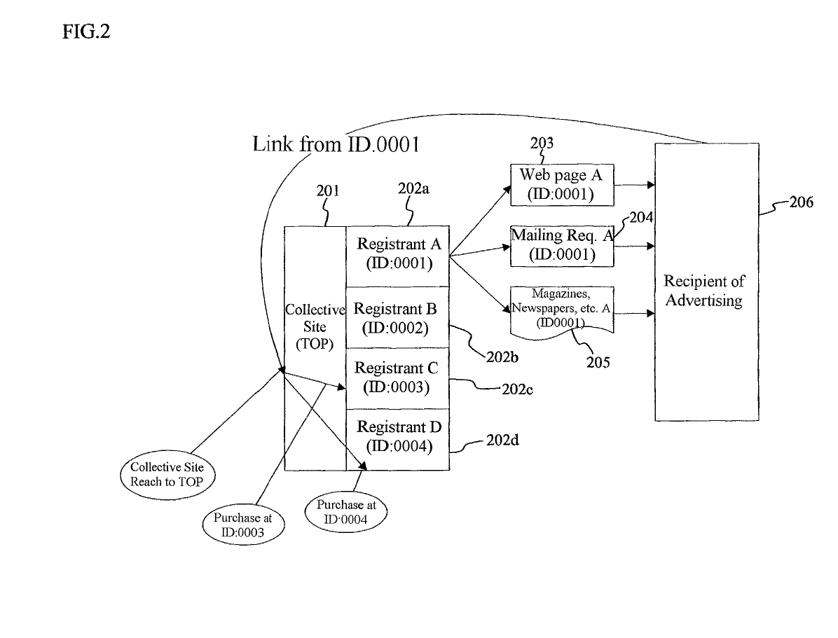

In a preferred embodiment of the present invention, as shown in FIG. 2, on a top page 201 of the shopping mall site, links to a webpage 202a, a webpage 202b and a webpage 202c, which are virtual stores opened by a registrant A, registrant B and registrant C, respectively, are provided.

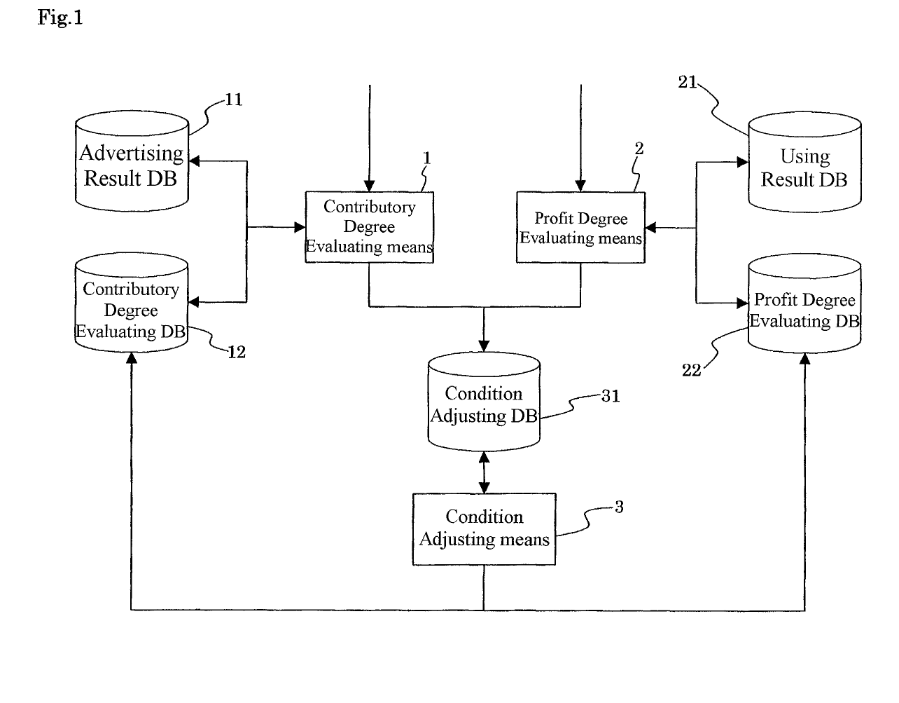

Referring to FIG. 1, the apparatus for adjusting a condition of using a collective site according to a preferred embodiment of the present invention includes a contributory degree evaluating means 1, a profit degree evaluating means 2 and a condition adjusting means 3.

Contributory degree evaluating means 1, profit degree evaluating means 2, and condition adjusting means 3 can be practiced with a computer and a program describing processes corresponding to each construction 1-3. A microprocessor of the computer is controlled by this program read into the memory of the computer.

Contributory degree evaluating means 1 evaluates the contributory degree of the advertisements for the shopping mall site which are carried out by each registrant. In order to evaluate the contributory degree, contributory degree evaluating means 1 refers to an advertising result database (hereinafter referred to as a advertising result DB) 11 and a contributory degree evaluating database (hereinafter referred to as a contributory degree evaluating DB) 12.

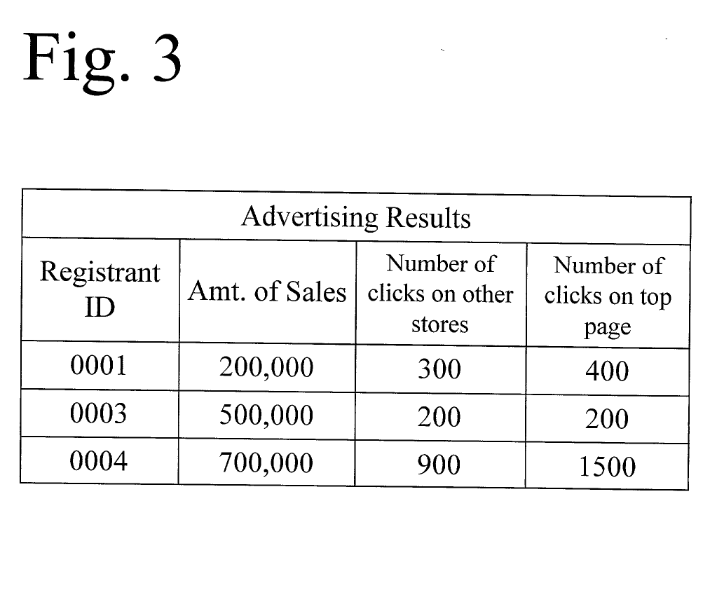

Advertising result DB 11 contains the totaled results of advertisements for the shopping mall site carried out by each registrant. Referring to FIG. 3, advertising result DB 11 provides the following: a field of an identification (hereinafter referred to as an ID) which is assigned for each registrant to identify them as a key field, a field of results of advertisements for the shopping mall site carried by each registrant by using their own advertising resources (websites, mailing list, magazines, news, etc.), a field of the amount of sales which are given in the shopping mall site, a field of the number of clicks on the other stores, and a field of the number of clicks on top page 201 of the shopping mall site.

In the example of FIG. 3, as a result of an advertisement by the registrant A who is assigned the ID of 0001, the amount of sales given in the shopping mall site is ¥20,000, the number of clicks on the other stores is 300, and the number of clicks on top page 201 of the shopping mall site is 400. As a result of an advertisement by the registrant C, who is assigned the ID of 0003, the amount of sales given in the shopping mall site is ¥50,000, the number of clicks on the other stores is 200, and the number of clicks on top page 201 of the shopping mall site is 200. Furthermore, as a result of an advertisement by the registrant D, who is assigned the ID of 0004, the amount of sales given in the shopping mall site is ¥70,000, the number of clicks on the other stores is 900, and the number of clicks on top page 201 of the shopping mall site is 1,500. The larger the number of clicks on top page 201 of the shopping mall site is, the higher a possibility that the audiences of the shopping mall site will increase. If the number of clicks on the other stores increases, usefulness of the shopping mall site is indicated not only for the audiences but also the other registrants. In this mean, the effect of the advertisement for the shopping mall site carried out by the registrant D is the highest.

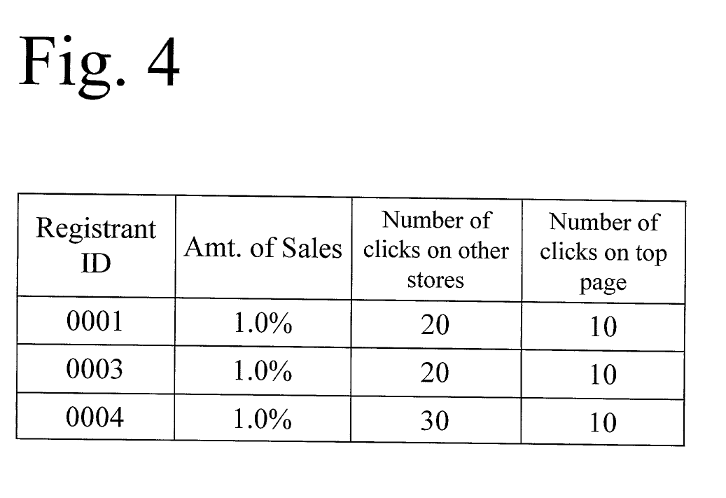

Furthermore, contributory degree evaluating DB 12 provides at least one of rate and unit cost, which results stored in each field of advertising result DB 11, except for the field of the ID, are converted into fees for using. The rate and the unit cost are provided in advance. The fees for using are paid by the registrants for a manager of the shopping mall site as a fee for using services, for example every month. Referring to FIG. 4, contributory degree evaluating DB 12 provides, in the same way as advertising result DB 11, the following: the field of the ID as a key field, a field of the amount of sales, a field of the number of clicks on the other stores, and a field of the number of clicks on the top page of the shopping mall site.

In the example of FIG. 4, for registrant A, who is assigned ID of 0001, the conversion rate of the amount of sales is 1.0%, the unit cost of the number of clicks on the other stores is ¥20/click, and the unit cost of the number of clicks on top page 201 of the shopping mall site is ¥10/click. For registrant C, who is assigned ID of 0003, the conversion rate of the amount of sales is 1.0%, the unit cost of the number of clicks on the other stores is ¥20/click, and the unit cost of the number of clicks on top page 201 of the shopping mall site is ¥10/click. Furthermore, for registrant D, who is assigned ID of 0004, the conversion rate of the amount of sales is 1.0%, the unit cost of the number of clicks on the other stores is ¥30/click, and the unit cost of the number of clicks on top page 201 of the shopping mall site is ¥10/click.

Contributory degree evaluating means 1 evaluates the amount corresponding to results of contribution of each registrant. In order to obtain the amount, contributory degree evaluating means 1 multiplies the amount of sales, the number of clicks on the other stores, and the number of clicks on top page 201 of the shopping mall site, by the conversion rates or the unit costs, and sums up each result of multiplication. The amount of sales, the number of clicks on the other stores, and the number clicks on top page 201 of the shipping mall site are read from advertising result DB 11. The conversion rates and the unit costs are read from contributory degree evaluating DB 12. The amounts in this evaluation are the specific examples of the contributory degree.

When the amount of sales, the number of clicks on the other stores, and the number of clicks on top page 201 of the shopping mall site are the same for each registrant, the contributory degree increases or decrease in portion to the conversion rate or the unit cost.

On the other hand, profit degree evaluating means 2 evaluates a profit degree, which is determined for each registrant by the use of the shopping mall site. In order to evaluate the profit degree, profit degree evaluating means 2 refers to a using result database (hereinafter referred to as a using result DB) 21 and a profit degree evaluating database (hereinafter referred to as a profit degree evaluating DB) 22.

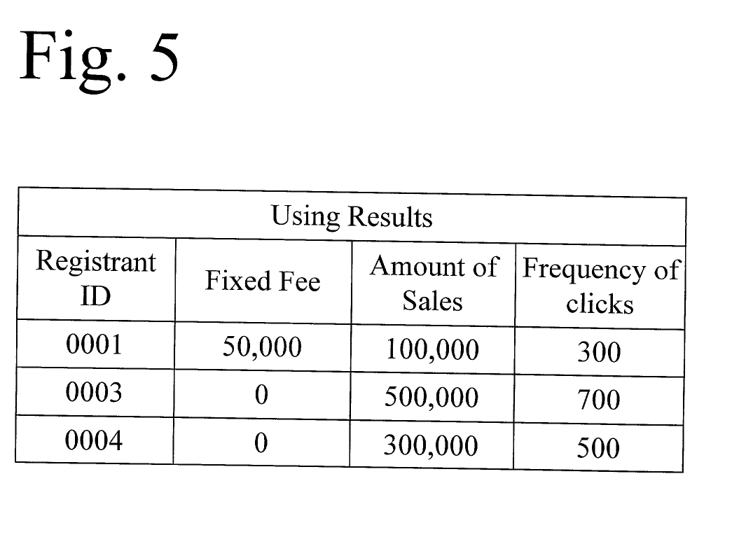

Using result DB 21 gives the totaled results of using the shopping mall site for each registrant. Referring to FIG. 5, using result DB 21 provides the following: the field of the ID as a key field, a field of a fixed fee, a field of the amount of sales given to each registrant by using the shopping mall site, and a field of the number of the click.

Herein, the fixed fee is, for example the fixed amount of profits for each month, which is expected in advance when each registrant uses the shopping mall site.

In the example of FIG. 5, when registrant A, who is assigned the ID of 0001, uses the shopping mall site, the fixed fee which is expected in advance is ¥50,000, the amount of sales given to registrant A by using the shopping mall site is ¥100,000, and the number of clicks on webpages of registrant A in the shopping mall site is 300. When registrant C, who is assigned the ID of 0003, uses the shopping mall site, the fixed fee which is expected in advance is ¥0, the amount of sales given to registrant C by using the shopping mall site is ¥500,000, and the number of clicks on webpages of registrant C in the shopping mall site is 700. Furthermore, when registrant D, who is assigned the ID of 0004, uses the shopping mall site, the fixed fee which is expected in advance is ¥0, the amount of sales given to registrant D by using the shopping mall site is ¥300,000, and the number of clicks on webpages of registrant D in the shopping mall site is 500. The larger the number of clicks and the amount of sales are, the larger each registrant receives direct profits and profit of advertising effect. In this mean, registrant C is given the largest profits by using the shopping mall site.

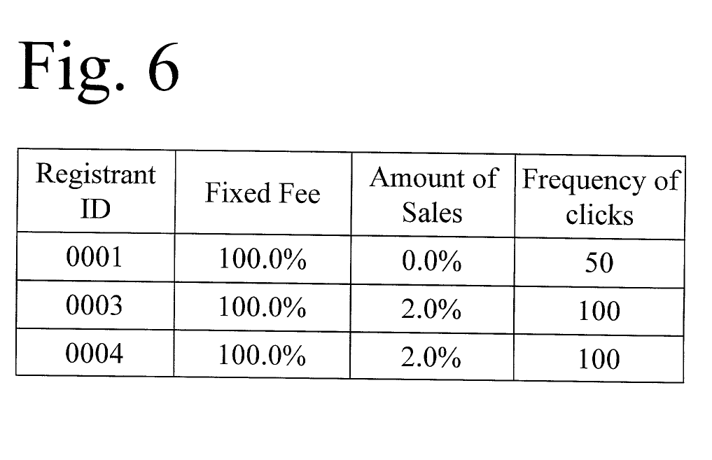

Profit degree evaluating DB 22 provides at least one of rate and unit cost, whereby results stored in each field of using result DB 21, except for the field of the ID, are converted into the fees for using. The rate and the unit cost are provided in advance. Referring to FIG. 6, profit degree evaluating DB 22 provides, in the same way as using result DB 21, the following: the field of the ID as a key field, a field of a fixed fee, a field of the amount of sales, and a field of the number of clicks.

In the example of FIG. 6, for registrant A, who is assigned ID of 0001, the conversion rate of the fixed fee is 100.0%, the conversion rate of the amount of sales is 0.0%, and the unit cost of the number of clicks is ¥50/click. In an example of FIG. 5, the fixed fee of ¥50,000 is provided only for registrant A. On the other hand, in an example of FIG. 6, corresponding to the fixed fee, the conversion rate of the amount of sales, 0.0%, is provided for registrant A, instead of the result of using, which is expected by the fixed fee in advance. Such mode may be stipulated freely by each registrant and the manager of the shopping mall site. For registrant C, who is assigned ID of 0003, the conversion rate of the fixed fee is 100.0%, the conversion rate of the amount of sales is 2.0%, and the unit cost of the number of clicks is ¥100/click. For registrant D, who is assigned ID of 0004, the conversion rate of the fixed fee is 100.0%, the conversion rate of the amount of sales is 2.0%, and the unit cost of the number of clicks is ¥100/click.

Profit degree evaluating means 2 evaluates the amount corresponding to results of profits given to each registrant. In order to obtain the amount, profit degree evaluating means 2 multiplies the fixed fee, the amount of sales, and the number of clicks, by the conversion rate or the unit cost. The fixed fee, the amount of sales, and the number of clicks are read from using result DB 21. The conversion rate and the unit cost are read form profit degree evaluating DB 22. The amounts in this evaluation are the specific examples of the profit degree.

When the fixed fee, the amount of sales, and the number of clicks are the same for each registrant, the profit degree increases or decreases in portion to the conversion rate or the unit cost.

The contributory degree, evaluated by contributory degree evaluating means 1, and the profit degree, evaluated by profit degree evaluating means 2, are supplied and stored in a condition adjusting database (hereinafter referred as a condition adjusting DB) 31.

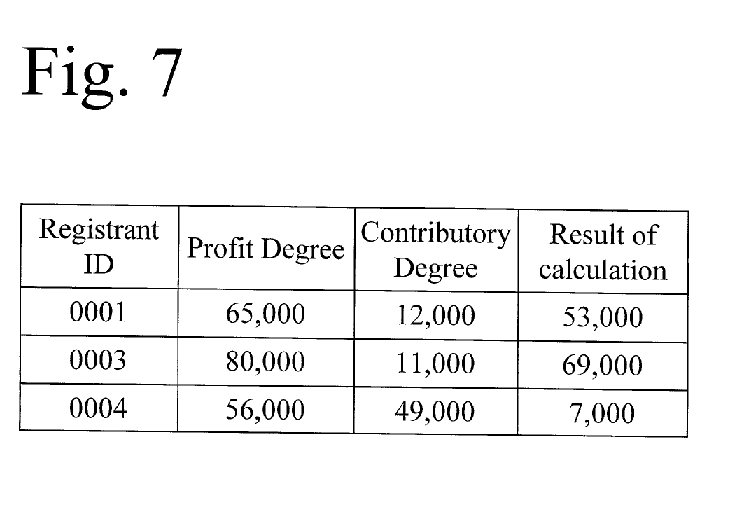

Referring to FIG. 7, condition adjusting DB 31 provides the following: the field of the ID as a key field, a field of the contributory degree, a field of the profit degree, and a field of a fee for using.

Condition adjusting means 3 reads the contributory degree and the profit degree which are stored in condition adjusting DB 31, adjusts the fee for using for each registrant in accordance with the contributory degree and the profit degree, and writes the result of adjustment in the field of the fee for using of condition adjusting DB 31.

To be concrete, a calculation of the fee for using is a simple one, wherein the contributory degree is subtracted from the profit degree.

In the example of FIG. 7, the profit degree of registrant A, who is assigned the ID of 0001, is ¥65,000, and the contributory degree is ¥12,000. In this case, condition adjusting means 3 subtracts ¥12,000 from ¥65,000 to get the result of the calculation, ¥53,000, and stores the result in the field of the fee for using of a record of registrant A in condition adjusting DB 31. The profit degree of registrant C, who is assigned ID of 0003, is ¥80,000, and the contributory degree is ¥11,000. In this case, condition adjusting means 3 subtracts ¥11,000 from ¥80,000 to get the result of the calculation, ¥69,000, and stores the result in the field of the fee for using of the record of registrant C in condition adjusting DB 31. Furthermore, the profit degree of registrant D, who is assigned ID of 0004, is ¥56,000, and the contributory degree is ¥49,000. In this case, condition adjusting means 3 subtracts ¥49,000 from ¥56,000 to get the result of the calculation, ¥7,000, and stores the result in the field of the fee for using of the record of registrant D in condition adjusting DB 31.

The apparatus for adjusting a condition of using a collective site, which is provided the above-mentioned constructions, is an appropriate apparatus for practicing the method of adjusting a condition of using a collective site according to a preferred embodiment of the present invention.

Subsequently, a description is now given of a method of adjusting a condition of using a collective site according to a preferred embodiment of the present invention, utilizing the apparatus for adjusting a condition of using a collective site.

Referring to FIG. 2, it is assumed that registrant A has advertising resources, such as a webpage 203, a mailing list 204, a magazine/newspaper 205, each of which belongs to three different classifications, besides the shopping mall site. It is also assumed that registrant C and registrant D have the same three types of advertising resources as registrant A. Registrant B is the only registrant that does not have these advertising resources.

In this case, at least for registrant A, registrant C, and registrant D, the condition of using such as a fee for using is adjusted by the method and apparatus for adjusting a condition of using a collective site according to a preferred embodiment of the present invention.

In the method of adjusting a condition of using a collective site according to the preferred embodiment of the present invention, the IDs are assigned to advertisements for the shopping mall site carried by each registrant in advance.

Each registrant can advertise in the shopping mall site using their own advertising resource, for example, by setting up at least one of banner advertisements and links of the shopping mall site on their own webpage 203. In advertising the shopping mall site, each registrant may put a link of the shopping mall site on mail sent by mailing list 204, which is managed by each registrant.

Like this, in the case where the banner advertisements and the links are used, the Ids, or information corresponding to the Ids, are annexed to these links.

The IDs are used in order to check which registrant's advertisement the audiences saw when the audiences visited to the shopping mall site. In the case where the webpages and the mailing lists are used in advertising, a route of links will be decided. Since a method of deciding the route of links is well-known, herein, only one example is indicated.

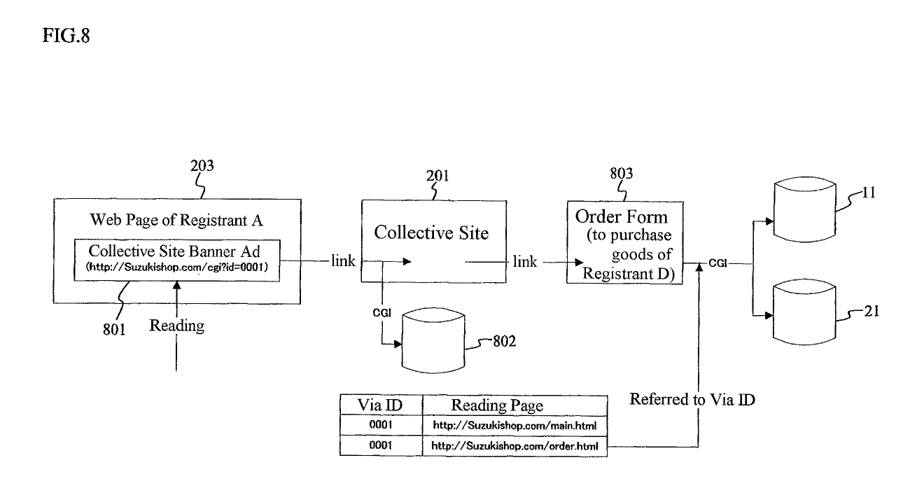

Referring to FIG. 8, on webpage 203, which is managed by registrant A, a banner advertisement 801 is set up in order to advertise the shopping mall site. The ID (0001), which is notified from the manager of the shopping mall site to registrant A in advance, is assigned to banner advertisement 801. In this example, a link of URL address designating a CGI, which has the ID (0001) as an argument, is embedded in banner advertisement 801.

As a receiver of advertisement 206 sees webpage 203 through a web browser and then clicks banner advertisement 801 with a mouse, a request designating the CGI as an argument is sent to a web server of the shopping mall site.

When the request designating the CGI, which has the ID (0001) as an argument, is received on the web server of the shopping mall site, the designated CGI starts to work. As the CGI begins to work, a directory of the webpage and the argument are captured from the request and delivered to a database server (not illustrated). By the database server, which manages a session by the receiver of advertisement 206, the directory of the webpage and the argument are recorded in a session managing database (hereinafter referred to as a session managing DB) 802 which records the session.

Furthermore, the webpage, which is designated by the directory captured from the request, in links of which the ID is embedded, for example, top page 201 of the shopping mall site, is generated by the CGI.

Next, it is assumed that the receiver of advertisement 206, who saw top page 201 of the shopping mall site, sent a request designating a webpage (order form) 803, wherein the goods of registrant D is bought (traded).

In response to the request, in the web server of the shopping mall site, in the same way as top page 201, the CGI starts to work. The argument and the directory of the webpage are recorded in session managing DB 802.

At this time, in session managing DB 802 records, as shown in FIG. 8, the following: the initial session, including the ID (0001) and the directory (http://Suzukishop.com/main.html, which corresponds to top page 201 of the shopping mall site), and the next session, including the ID (0001) and the directory (http://Suzukishop.com/order.html, which corresponds to an order form of registrant D of the shopping mall site), for the receiver of advertisement 206.

Order form 803 of registrant D is supplied to the web server of the shopping mall site and sent to the web browser of the receiver of advertisement 206 by the web server.

After order form 803 of registrant D was displayed on the web browser, a request designating that the receiver of advertisement 206 confirmed a purchase of the goods of registrant D, is sent to the web server from the web browser.

When the web server received the request, the CGI starts to work. At this time, by using the CGI, the content of records of advertising result DB 11 and using result DB 21 are renewed.

In this example, since, due to the advertisement carried out by registrant A, the top page of the shopping mall site and the order form of registrant D are selected, the number of clicks on the other stores and the number of clicks on top page 201 of the shopping mall site in the records of registrant A in advertising result DB 11 increases by one, due to the CGI. Since the goods of registrant D were pirchased, the amount of sales in the record of registrant A in advertising result DB 11 increases by the amount of the goods.

On the other hand, registrant D is given profits by using the shopping mall site. The amount of sales in the record of registrant D in using result DB 21 increases by the amount of the goods. The number of clicks increases by at least one.

As a result of repeating such processes, advertising result DB 11 and using result DB 21 are constructed. (The amount of sales and the number of clicks are totaled.)

Still furthermore, in the case where magazine/newspaper 205 is used in advertising, as well, the IDs of the registrants who carries advertisements or some such corresponding information is put in the advertisements. In this case, it is natural to put words (keywords), which are provided for the registrants in advance, in the advertisements. It is probable that the keywords should be inputted when the top page of the shopping mall site is visited. In this case, the manager of the shopping mall site may receive the orders via telephone or facsimile. In the case where the orders are received via telephone or facsimile, as well, the keywords should be confirmed. In the case where the orders are received via telephone or facsimile, although it is expected that the receiver of advertisement 206 will not visit the shopping mall site, the registrants, who received orders, are given profits by using the shopping mall site in the end. Furthermore, in the case where the orders are received via telephone or facsimile, it is necessary that the ID specified by the keyword is inputted and recorded in advertising result DB 11 and using result DB 21 by the operator. At least the amounts of sales in the advertising result DB and the using result DB are renewed.

The apparatus for adjusting a condition of using a collective site works when it receives instructions from the operator, or on the fixed time and date. For example, the apparatus may be set to work on the day before the fee for using is charged for each registrant.

When the apparatus for adjusting a condition of using a collective site works, contributory degree evaluating means 1 evaluates the contributory degree, referring to advertising result DB 11 and contributory degree evaluating DB 12, and condition adjusting DB 31 is renewed.

Furthermore, profit degree evaluating means 2 evaluates the profit degree, referring to using result DB 21 and profit degree evaluating DB 22, and condition adjusting DB 31 is renewed.

Still further, condition adjusting means 3 adjusts the condition of using such as a fee for using in accordance with the contributory degree and the profit degree, referring to condition adjusting DB 31, and the adjusted fee is written in condition adjusting DB 31.

In this way, the fee for using is adjusted, for example, for each month or for each registrant. In the example of FIG. 7, the fee for using for registrant D, whose contributory degree is the highest, is ¥7,000, which is cheaper than that of any other registrants. As a result, the incentive for registrant D to use the shopping mall site is enhanced. Although the fee for using for registrant C is ¥69,000, which is the highest in three of the registrants, profits given to registrant C is large enough not to lose the incentive to use the shopping mall site.

Still further, in the above preferred embodiment, the present invention is applied to the shopping mall site. However, without limiting within the shopping mall site, the method and apparatus for adjusting a condition of using a collective site in the present invention can be applied to the other types of collective site such as a link-listed site. In that case, it is not necessary to carry out both of advertisements and transactions. In the collective site, the registrants can be given profits when either of advertisements or transactions are carried out.

Furthermore, the method of deciding a route of links is not limited within the content of the preferred embodiment. What should be evaluated are only advertising results and using results, by assigning the IDs or the corresponding information of the registrants to advertisements for the collective site carried out by each registrant in advance.

Furthermore, the conversion rate or unit cost stored in contributory degree evaluating DB 12 and in profit degree evaluating DB 22 may be adjusted in accordance with the contributory degree and the profit degree, wherein the fee for using will be adjusted in the end. In this case, the conversion rate or the unit cost is the specific example of the condition of using.

Still further, regardless of the fee for using, for example, the degree of priority in assigning each registrant to webpages provided in the collective site may be adjusted. Some parts of the webpages provided in the collective site are easy to attract attention by the audiences, and other parts of the webpages are not. If the other conditions are the same, the deeper the level of webpage from the top page of the collective site, the more difficult it is to attract attention by the audiences. The shallower the level of webpage from the top page of the collective site, the easier it is to attract attention by the audiences. Even if the registrants are assigned territories on the same webpage, the degrees of attention to each registrant are different by the position of territories on the webpage. Furthermore, the smaller a territory assigned in the webpage, the more difficult it is to attract attention by the audiences. The larger a territory assigned in the webpage, the easier it is to attract attention by the audiences. Besides the above factors, if such terms and symbols “NEW”, “ATTENTION” and “SPECIAL” as make an evaluation, are added near links, the audiences' way of getting interest in the links is different due to these words. For example, corresponding to the audiences' way of getting interest, the assignments of webpages are ranked for each registrant. In the case where the terms and symbols such as “ATTENTION”, “NEW” and “☆☆☆” is added near a link, the rank of the link is high. In the case where the terms and symbols are not added or a symbol “☆”, which suggests that an evaluation of the link is not high is added, the rank of the link is low. If the level is shallow, the rank is high. If the level is deep, the rank is low. For example, after links are ranked in this way, the way of assigning high ranks is applied for the registrants whose priority is high. The way of assigning low ranks is applied for the registrants whose priority is low. As mentioned above, when the priority in assigning each registrant to webpages provided in the collective site is adjusted, the incentive for each registrant to use the collective site can be changed.

Furthermore, in the case where the condition of using is adjusted, like the preferred embodiment described above, the condition of using may be adjusted in accordance with only the contributory degree, without using both of the contributory degree and the profit degree. In this case, if the effect of advertisement carried out by each registrant is high, the fee for using is reduced. In this way, it is possible to enhance the incentive for each registrant to use the collective site while the size of the audience increases. However, in this case, there is a possibility that the registrants whose advertisement made great effect will lose their incentive to use the collective site. Therefore, it is preferable that the condition of using is adjusted in accordance with the contributory degree and the profit degree, like the preferred embodiment.

As described above, due to the method and apparatus for adjusting a condition of using a collective site, the incentive for the registrants to use the collective site can be enhanced, while the size of the audience increases.

Specially, in the case where the condition of using is adjusted in accordance with the contributory degree of advertisement for the collective site carried by each registrant and the profit degree given to each registrant by using the collective site, there is no possibility to lose the incentive for each registrant to use the collective site because of unfairness between the registrants.

Still further, since the registrants advertise the collective site by using their own advertising resources, it is secured that the chances that the audiences who are interested in the collective site see the registrants' own webpages will increase, and that the size of the audience who os interested in the registrants themselves will be increase.

Further, by managing and freely adjusting the conversion rate and the unit cost which are stored in contributory degree evaluating DB 12 and using result evaluating DB 22, profits of the collective site can be led most profitably.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method of adjusting a condition of using a collective site for a plurality of registrants who have been registered in advance, wherein at least one of advertisements and transactions is carried out regarding the registrants, comprising the steps of:
evaluating a contributory degree of advertisements for said collective site, which are carried out by each registrant; and
adjusting said condition for each registrant in accordance with said contributory degree.

2. The method of adjusting a condition of using a collective site for a plurality of registrants as set forth in claim 1 further comprising the steps of:
evaluating a profit degree, which is given to each registrant by using said collective site prior to said adjusting step, wherein said condition for each registrant is adjusted in accordance with said profit degree as well as said contributory degree.

3. The method of adjusting a condition of using a collective site for a plurality of registrants as set forth in claim 1 wherein said condition is a fee for using said collective site.

4. The method of adjusting a condition of using a collective site for a plurality of registrants as set forth in claim 1 wherein said condition is a degree of priority in assigning territories on webpages to each registrant, said webpages being provided in said collective site.

5. The method of adjusting a condition for using a collective site for a plurality of registrants as set forth in claim 1 wherein said collective site is a shopping mall site, assigning territories on webpages to each registrant, said webpages being provided in said collective site to carry out advertisements and transactions for goods and services of the registrants.

6. An apparatus for adjusting a condition of using a collective site for a plurality of registrants who have been registered in advance, wherein at least one of advertisements and transactions is carried out regarding the registrants comprising:
contributory degree evaluating means for evaluating a contributory degree of advertisements for said collective site which are carried out by each registrant;
profit degree evaluating means for evaluating a profit degree, obtained by each registrant by using said collective site; and
condition adjusting means for adjusting the condition for each registrant in accordance with said contributory degree and said profit degree.

7. The apparatus for adjusting a condition of using a collective site for a plurality of registrants as set forth in claim 6 wherein said condition is a fee for using said collective site.

8. The apparatus for adjusting a condition of using a collective site for a plurality of registrants as set forth in claim 6 wherein said condition is a degree of priority in assigning territories on webpages to each registrant, said webpages being provided in said collective site.

9. The apparatus for adjusting a condition for using a collective site for a plurality of registrants as set forth in claim 6 wherein said collective site is a shopping mall site, assigning territories on webpages to each registrant, said webpages being provided in said collective site to carry out advertisements and transactions for goods and services of the registrants.
